(19) United States
(12) Patent Application Publication
(10) Pub. No.: US 2024/0148592 A1
(43) Pub. Date: May 9, 2024

(54) MASSAGE DEVICE COMPRISING ROTATABLE ARM MASSAGE PART

(71) Applicant: BODYFRIEND CO., LTD., Seoul (KR)

(72) Inventors: Ju Song HUR, Seoul (KR); Beom Seok LEE, Seoul (KR); Woong Chul KANG, Seoul (KR)

(21) Appl. No.: 18/280,835

(22) PCT Filed: Jun. 8, 2022
(86) PCT No.: PCT/KR2022/008081

§ 371 Date: Sep. 7, 2023

(30) Foreign Application Priority Data
Jun. 9, 2021 (KR) 10-2021-0074698
Sep. 16, 2021 (KR) 10-2021-0124244
Sep. 16, 2021 (KR) 10-2022-0049170

(51) Int. Cl. A61H 1/02; A61H 7/00

(52) U.S. Cl. CPC A61H 1/0274; A61H 7/004; A61H 2201/0107; A61H 2201/0196; A61H 2201/1635; A61H 2201/1671

(57) ABSTRACT

The present invention relates to a massage device including a rotatable arm massage part and, more specifically, to a massage device having an arm massage part rotatably provided thereto so that various functions can be provided to a user. To this end, an aspect of the present invention includes: a body massage part including a main frame forming a skeleton of a massage device and massaging the body of a user; and arm massage parts disposed at opposite sides of the body massage part to receive both arms of the user, respectively, and massaging the arms of the user, wherein the main frame may include an arm fixing frame to which the arm massage part is connected, and the arm massage part may include an arm moving frame rotatable in at least one direction with reference to the arm fixing frame.

### TECHNICAL FIELD

The present invention relates to a massage device comprising a rotatable arm massage part, and more particularly, to a massage device capable of providing various functions to a user by including a rotatable arm massage part.

### BACKGROUND ART

Massage is a medical assistance therapy for controlling a user's physical modulation, helping blood circulation, and relieving fatigue of the user by applying various types of mechanical stimulation to a portion of the body, such as massaging, pressing, pulling, tapping, or moving a portion of the body of the user.

The growth in a massage demand caused an increase in demand for massage devices or massage devices, which provide an artificial massage function, because of economic feasibility and temporal reasons. That is, as the demand for relieving fatigue or stress is increased while loosening the agglomerated muscles through massage, various mechanical massage devices for time and cost efficiencies are being released.

Recently, there is an increase in interest in health of people, and the massage device is changing as an electronic device providing various additional functions, and/or medical functions from a device simply providing a massage function. Accordingly, researches on how to efficiently control a massage device are continued.

In particular, since users may have different regions to get a massage and may be different in desired stimulation from one another, the demand for apparatuses and methods providing a massage optimized for each user is increasing.

### DISCLOSURE

### Technical Problem

An object of the present invention is to provide a massage device including a rotatable arm massage part to provide various functions to a user.

Another object of the present invention is to provide a massage device providing various massage functions and stretching functions to the user's arm by rotating an arm massage part up and down or left and right.

The objects of the present invention are not limited to the above-mentioned effects, and other effects, which are not specifically mentioned herein, will be clearly understood by those skilled in the art from the following description.

### Technical Solution

To accomplish the above-mentioned objects, according to the present invention, there is provided a massage device including: a body massage part including a main frame forming a framework of the massage device, and massaging a user's body; and an arm massage part positioned on both sides of the body massage part, each accommodating an arm of the user to massage the user's arm, wherein the main frame includes an arm fixing frame to which the arm massage part is connected, and wherein the arm massage part includes an arm moving frame capable of rotating in at least one direction based on the arm fixing frame.

Moreover, the massage device further includes a rotation module to rotate the arm massage part in at least one direction.

Furthermore, the rotation module includes: a first rotation module for rotating the arm massage part vertically, and a second rotation module for rotating the arm massage part horizontally.

Additionally, the first rotation module comprises a first rotation actuator extended in a predetermined direction, and the second rotation module comprises a second rotation actuator extended in a direction different from that of the first rotation actuator.

In addition, a virtual extension line extended in the length direction of the arm fixing frame and a virtual extension line extended in the extension direction of the second rotation module intersect with each other.

Moreover, the rotation module comprises a support plate which is positioned between the first rotation module and the second rotation module, and has one side connected to the first rotation module and the other side connected to the second rotation module.

Furthermore, the support plate is rotated by the second rotation module.

Additionally, the massage device further includes an arm length adjustment module to adjust the length of the arm massage part.

Moreover, the arm length adjustment module comprises an arm position sensor to recognize the position of the arm massage part.

In addition, the massage device further includes a control unit controlling the operation of the massage device, wherein the control unit controls the arm length adjustment module to adjust the length of the arm massage part based on the rotation amount of the arm massage part.

### Advantageous Effects

According to the present invention, it is possible to provide a massage device capable of providing various functions to a user.

In addition, according to the present invention, it is possible to provide a massage device capable of providing various massage functions and stretching functions to the user's arm by rotating an arm massage part up and down or left and right.

The effects of the present invention are not limited to the above-mentioned effects, and other effects, which are not specifically mentioned herein, will be clearly understood by those skilled in the art from the following description.

### DESCRIPTION OF DRAWINGS

FIG. 1 is a view illustrating a massage device according to an embodiment of the present invention.

FIG. 2 is a view illustrating a main frame of FIG. 1.

FIG. 3 is a view for depicting components of a massage device according to an embodiment of the present invention.

FIG. 4 is a view illustrating a rotation module and an arm length adjusting module provided in the main frame of FIG. 2.

FIG. 5 is a view illustrating that an arm massage part rotates in one direction.

FIG. 6 is a view for depicting a rotation principle of the arm massage part of FIG. 5.

FIG. 7 is a view illustrating that the arm massage part rotates in a different direction.

FIG. 8 is a view for depicting a rotation principle of the arm massage part of FIG. 7.

FIG. 9 is a view illustrating the rotation module of FIG. 4.

FIG. 10 is a view illustrating a first rotation module of FIG. 9.

FIG. 11 is a view illustrating the first rotation module of FIG. 9 viewed from another angle.

FIG. 12 is a view illustrating an operational principle of the first rotation module of FIG. 9.

FIG. 13 is a view illustrating a second rotation module of FIG. 9.

FIG. 14 is a view illustrating the second rotation module of FIG. 9 viewed from another angle.

FIG. 15 is a view illustrating an example having a bearing provided on the second rotation module of FIG. 9.

FIG. 16 is a view illustrating an operational principle of the second rotation module.

FIG. 17 is a view illustrating the arm length adjusting module of FIG. 4.

FIG. 18 is a view illustrating a state in which an arm massage part housing is removed from FIG. 17.

FIG. 19 is a view illustrating an example having an arm position sensor provided on the arm length adjusting module of FIG. 17.

FIG. 20 is a view illustrating a position of a first rotation actuator.

FIG. 21 is a view illustrating a change in length of the arm massage part according to angles of the arm.

### BEST MODE

There is a massage device including: a body massage part including a main frame forming a framework of the massage device, and massaging a user's body; and an arm massage part positioned on both sides of the body massage part, each accommodating an arm of the user to massage the user's arm, wherein the main frame includes an arm fixing frame to which the arm massage part is connected, and the arm massage part includes an arm moving frame capable of rotating in at least one direction based on the arm fixing frame.

### MODE FOR INVENTION

The objects, features, and advantages of the present invention described above will become more apparent through the following embodiments in connection with the accompanying drawings. The following specific structure to functional descriptions are illustrated for the purpose of describing an embodiment according to the concept of the present invention, and embodiments according to the concept of the present invention may be implemented in various forms and should not be construed as being limited to the embodiments described herein or the application.

The embodiments according to the concepts of the present invention may apply various changes and may have various forms, and thus certain embodiments are illustrated in the drawings and will be described in detail in the specification or application. However, it should be understood that the embodiments of the present invention are not intended to limit the embodiments of the present invention to a specific disclosure, and include all modifications, equivalents, and replacements included in the spirit and technical scope of the present invention.

Terms such as first and/or second may be used to describe various components, but the components are not limited to the terms. The terms are only for the purpose of distinguishing one component from other components, for example, without departing from the scope of the present invention, a first component may be referred to as a second component, and similarly, a second component may also be referred to as a first component.

It should be understood that when a component is referred to as being “connected” or “coupled” to another component, it may be directly connected or coupled to the other component, but it should be understood that there may be other components therebetween. On the other hand, when a component is referred to as being “directly connected” or “directly coupled” to another component, it should be understood that there is no other component therebetween. Other expressions for describing the relations between the components, that is, the expression “between” and “directly between” or “adjacent to” and “directly adjacent to” should be interpreted in the same manner.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

In this specification, an actuator means a component capable of providing a driving force. For instance, the actuator may be a motor, a linear motor, an electronic motor, a DC motor, an AC motor, a linear actuator, an electric actuator, or the like, but is not limited thereto.

In this specification, a binaural beat may refer to audio information of a specific form capable of adjusting brainwaves.

In this specification, according to an embodiment, the massage device may include a body massage part and a leg massage part. In addition, according to another embodiment, the body massage part and the leg massage part may be provided as separate devices (for example, a body massage device and a leg massage device), and the massage device may refer to a body massage device or a leg massage device.

Hereinafter, embodiments of the present invention will be described in more detail with reference to the accompanying drawings.

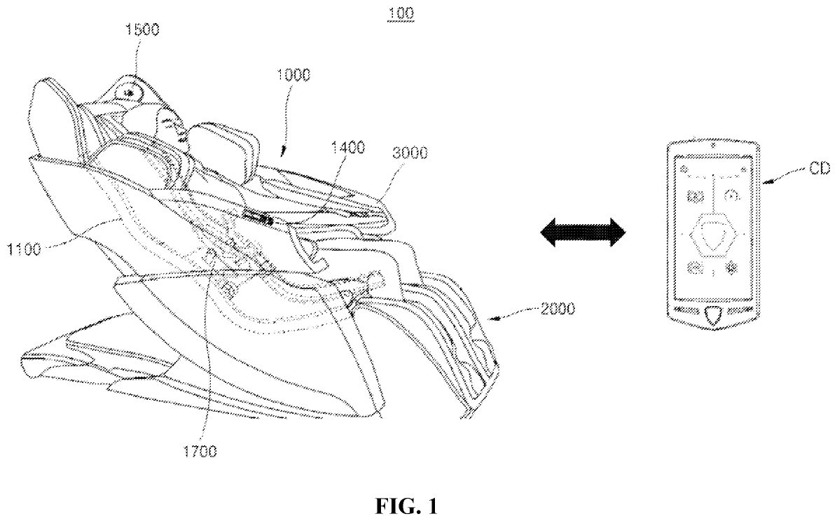

FIG. 1 is a view illustrating a massage device 100 according to an embodiment of the present invention.

The massage device 100 according to an embodiment of the present invention may include a body massage part 1000 having an area for accommodating at least a portion of the body of a user to massage the user's body, and a leg massage part 2000 to massage the user's legs.

The body massage part 1000 may provide a massage to at least a portion of the body of the user. The body massage part 1000 may include a massage module 1700 providing a massage function to at least a portion of the body of the user, an audio output module 1500 for providing an audio output of an arbitrary form to the user, a main frame 1100 forming a framework of the body massage part 1000, and a user input unit 1400 for receiving an input of an arbitrary form from the user.

The components included in the body massage part 1000 described above are merely exemplary embodiments, and the body massage part 1000 may include various configurations in addition to the above-described configuration.

In addition, the shape and the structure of the massage device 100 illustrated in FIG. 1 are merely exemplary, and various types of massage devices 100 may also be included within the scope of the present invention unless departing from the scope of the present invention defined by the claims of the present invention.

The body massage part 1000 may have a space of any form for accommodating a user. The body massage part 1000 may have a space corresponding to the body shape of the user. For example, as illustrated in FIG. 1, the body massage part 1000 may be realized as a seating type capable of accommodating the whole body or a portion of the body of the user.

A portion of the body massage part 1000 which gets in contact with the ground may include any material for increasing a frictional force or any member (for example, an anti-slip pad or the like) for increasing a frictional force, and may include wheels for enhancing mobility of the massage device 100.

At least a portion of the body massage part 1000 may slide. For example, when the body massage part 1000 starts a massage, at least a portion of the body massage part 1000 may slide forward. Furthermore, the body massage part 1000 may be tilted backward. As a result, the body massage part 1000 may provide a massage while being inclined backward.

According to an embodiment of the present invention, the massage device 100 may include at least one air cell (not illustrated). The air cell may be located at a shoulder portion of the user, a pelvis portion, an arm massage part, a leg massage part 2000, and the like, but is not limited thereto and may be disposed in various portions of the massage device 100.

The massage device 100 may include an air supply unit, and the air supply unit may inflate the air cell when air is supplied to the air cell. The air supply unit may be located inside the body massage part 1000 or may be located in the leg massage part 2000. Alternatively, the air supply unit may be located outside the massage device 100.

The leg massage part 2000 may provide the user with a leg massage. For example, the leg massage part 2000 may include a calf massage part for massaging the user's calf and/or a foot massage part for massaging the user's foot.

The leg massage part 2000 may adjust the length according to the body characteristics of the user. For example, in a case in which a user who is tall uses the massage device 100, it is necessary to lengthen the leg massage part 2000 since the user has long calves. Moreover, in a case in which a user who is short uses the massage device 100, it is necessary to shorten the leg massage part 2000 since the user has short calves.

The massage module 1700 may be provided inside the body massage part 1000 to provide any type of mechanical stimulation to the user accommodated in the body massage part 1000. As illustrated in FIG. 1, the massage module 1700 may move along the main frame 1100 provided inside the body massage part 1000.

For example, a rack gear may be provided in the main frame 1100 of the body massage part 1000, and the massage module 1700 may provide dynamic stimulation to various portions of the body of the user while moving along the rack gear 1111. The massage module 1700 may include a ball massage part or a roller massage part, but is not limited thereto.

The main frame 1100 constitutes a frame of an internal configuration of the body massage part 1000, and may be formed of a metal material, a plastic material, or the like. For example, the main frame 1100 may be made of iron, an alloy, steel, or the like, but is not limited thereto, and may be made of various rigid materials.

According to an embodiment of the present invention, the massage device 100 may include an audio output module 1500. The audio output module 1500 may be provided at various positions. For example, the audio output module 1500 may include a plurality of output units, such as an upper audio output unit disposed on an upper end of a seat portion getting in contact with a user, a front audio output unit attached to a front end of the arm massage part of the right and left sides of the seat portion, and/or a rear audio output unit attached to a rear end of the arm massage part, but is not limited thereto. In this case, the audio output module 1500 may provide a stereoscopic sound, such as a 5.1 channel sound, but is not limited thereto.

According to an embodiment of the present invention, the user may control the massage device 100 by using a massage device control device CD. The massage device control device CD may be connected to the massage device 100 through wired communication and/or wireless communication.

The massage device control device CD may include a remote controller, a cellular phone, a personal digital assistant (PDA), or the like, and may include various electronic devices connectable to the massage device 100 through wired or wireless communication.

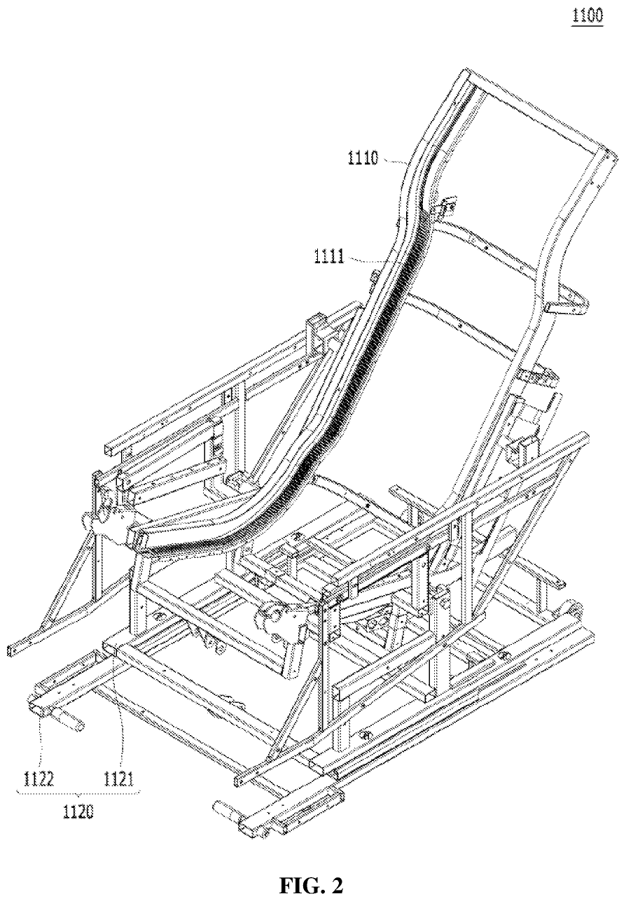

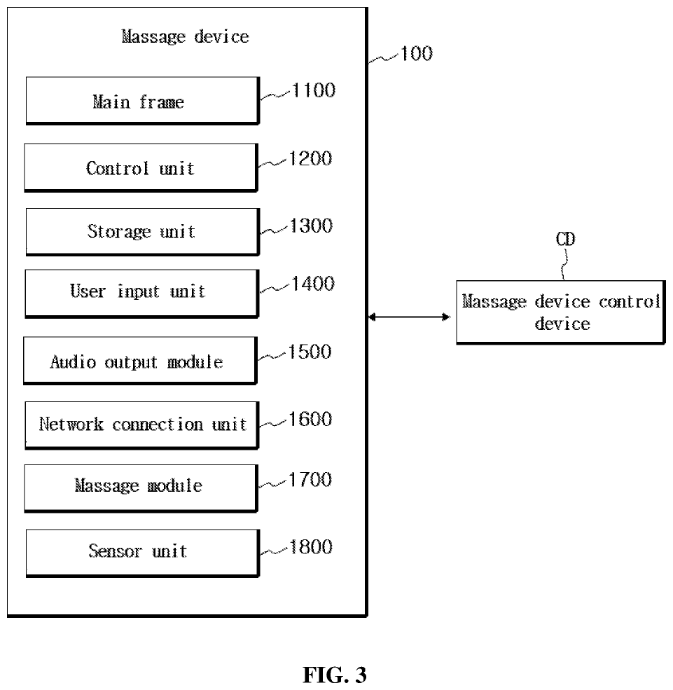

FIG. 2 is a view illustrating a main frame of FIG. 1, and FIG. 3 is a view for depicting components of the massage device according to an embodiment.

According to an embodiment of the present invention, the massage device 100 may include at least one among a main frame 1100, a control unit 1200, a storage unit 1300, a user input unit 1400, an audio output module 1500, a network connection unit 1600, and a massage module 1700.

The main frame 1100 may form a frame of the body massage part 1000.

According to an embodiment of the present invention, the main frame 1100 may include an upper frame 1110 provided with the massage module 1700 and a base frame 1120 supporting the upper frame 1110.

A rack gear 1111 may be provided on at least a portion of the upper frame 1110. The rack gear 1111 is a member for guiding a vertical movement of the body massage module 1700, and may include a plurality of valleys and a plurality of crests.

According to an embodiment of the present invention, the rack gears 1111 may be provided at both sides of the upper frame 1110 to face each other, and the body massage module 1700 may move along the rack gears 1111.

For example, the body massage module 1700 may include a gear engaged with the rack gear 1111, and the gear is rotated by an actuator provided in the body massage module 1700, so that the body massage module 1700 may move upward or downward.

The rack gear 1111 may be formed of a metal material or a plastic material. For example, the rack gear 1111 may be made of iron, steel, an alloy, a reinforced plastic, a melamine resin, a phenol resin, or the like, but is not limited thereto.

The upper frame 2230 may be realized in various shapes. For example, the upper frame 2230 may be one selected among an S frame, an L frame, an S&L frame, and a double S&L frame according to the shape of the upper frame, but is not limited thereto.

The S frame refers to a frame in which at least a portion of the upper frame 2230 has a curved shape like “S”. The L frame refers to a frame in which at least a portion of the upper frame 2230 is bent like “L”, the S&L frame refers to a frame having both of the curved shape like “S” and the bent shape like “L”, and the double S&L frame refers to a frame having the curved shape like “L” and the curved shape like “S” formed at two portions.

The base frame 1120 supports the upper frame 1110 of the main frame 1100 and gets in contact with the ground. The base frame 1120 may include a base upper frame 1121 and a base lower frame 1122.

The base upper frame 1121 may support the upper frame 1110, and the base lower frame 1122 may be in contact with the ground. In addition, the base upper frame 1121 may be positioned to be in contact with the base lower frame 1122.

According to an embodiment of the present invention, the base upper frame 1121 may move along the base lower frame 1122. For example, the base upper frame 1121 may slide forward or backward along the base lower frame 1122. In this case, the upper frame 1110 may be connected to the base upper frame 1121 to move according to the movement of the base upper frame 1121.

For example, in a case in which the base upper frame 1121 moves forward, the upper frame 1110 may also move forward, and in a case in which the base upper frame 1121 moves backward, the upper frame 1110 may also move backward. Accordingly, the sliding movement of the body massage part 1000 may be allowed.

Specifically, in order to allow movement of the base upper frame 1121, a moving wheel may be provided beneath the base upper frame 1121. In addition, a guide member capable of guiding the moving wheel may be provided on an upper portion of the base lower frame 1122. The moving wheel provided beneath the base upper frame 1121 moves along the guide member provided on the base lower frame 1122, thereby allowing forward movement or backward movement of the base upper frame 1121.

According to another embodiment of the present invention, the massage device 100 may not provide a sliding function, and in this case, the base frame 1120 may not be divided into an upper frame and a lower frame.

The control unit 1200 may control the operation of the massage device 100. The control unit 1200 may be implemented as one processor or may be implemented as a plurality of processors. In a case in which the control unit 1200 is realized as a plurality of processors, at least a portion of the plural processors may be physically spaced apart from each other. In addition, the massage device 100 is not limited thereto, and may be implemented in various ways.

For instance, the control unit 120 may correspond to one or more processors. The processor may be implemented as arrays of plural logic gates, or may be implemented as a combination of a general-purpose microprocessor and a memory in which programs executable in the microprocessor are stored. Furthermore, it would be understood by those skilled in the art that the control unit may be implemented as another type of hardware.

According to an embodiment of the present invention, the control unit 1200 may control the operation of the massage device 100. For example, the massage device 100 may include a plurality of actuators. The massage device 100 may control the operation of the massage device 100 by controlling the operation of the plurality of actuators. For example, the massage device 100 may include at least one among a massage module moving actuator, at least one actuator included in the massage module 1700, a back angle actuator, a leg angle actuator, a foot massage actuator, a leg length adjusting actuator, and a sliding actuator, and the control unit 1200 may control the operation of the massage device 100 by controlling them.

The massage module moving actuator is an actuator that enables vertical movement of the massage module 1700, and the massage module 1700 may move along the rack gear by the operation of the massage module moving actuator.

The back angle actuator is an actuator that adjusts an angle of a portion where the back of the user gets in contact with the massage device 100, and the back angle of the massage device 100 may be adjusted by the operation of the back angle actuator.

The leg angle actuator is an actuator for adjusting an angle of the leg massage part 2000 of the massage device 100. An angle between the leg massage part 2000 and the body massage part 1000 may be adjusted by the operation of the leg angle actuator.

The foot massage actuator is an actuator that operates the foot massage module included in the leg massage part 2000. The massage device 100 may provide a foot massage to the user utilizing the foot massage actuator.

The massage module 1700 may include at least one actuator, and the control unit 1200 may operate at least one actuator to provide various massage motions. For example, the control unit 1200 may operate at least one actuator included in the massage module 1700 to provide a tapping massage, a kneading massage, and the like, and may provide various massage operations without being limited thereto.

The leg length adjusting actuator represents an actuator that adjusts the length of the leg massage part 2000. For example, the control unit 1200 may adjust the length of the leg massage part 2000 to be suitable for the user by utilizing the leg length adjusting actuator, and as a result, the user may receive a massage suitable for the user's body shape.

The sliding actuator enables a sliding motion of the massage device 100. For example, a horizontal base upper frame may move forward or backward by the operation of the sliding actuator, and as a result, the upper frame 1110 connected to the horizontal base upper frame 1121 may also move forward or backward.

The storage unit 1300 may store various pieces of information related to the massage device 100. For example, the storage unit 1300 may include massage control information and personal authentication information, but is not limited thereto.

The storage unit 1300 may be implemented through a non-volatile storage medium capable of continuously storing arbitrary data. For example, the storage unit 1300 may include not only a disk, an optical disk, and a magneto-optical storage device, but also a storage device based on a flash memory and/or a battery-backup memory, but is not limited thereto.

In addition, the storage unit 1300 may include a memory. The memory may be a primary storage device, to which a processor directly accesses, like a random access memory (RAM), such as a dynamic random access memory (DRAM), a static random access memory (SRAM), or the like. The memory may mean a volatile storage device in which stored information is instantaneously erased when power is turned off, but is not limited thereto. The memory may be operated by the control unit 1200.

The user input unit 1400 may receive a command related to the operation control of the massage device 100 from the user, and the user input unit 1400 may be implemented in various forms. For example, the user input unit 1400 may be provided in the body massage part 1000, or may be provided in the leg massage part 2000, but is not limited thereto.

The massage device 100 may receive various commands from the user through the user input unit 1400. For example, the massage device 100 may receive commands related to selection of a massage module, selection of a massage mode, selection of massage intensity, selection of massage time, selection of a massage area, selection of a position and an operation of the body massage part 1000, selection of power On-Off of the massage device 100, selection of an operation state of a thermal function, selection related to sound reproduction, and the like, but is not limited thereto.

According to another embodiment of the present invention, the user input unit 1400 may include hot key type buttons and/or selection buttons for direction selection, cancellation and input according to preset user setting functions or preset self-setting functions.

The user input unit 1400 may be implemented as a keypad, a dome switch, a (static pressure type/capacitive) touch pad, a jog wheel, a jog switch, or the like, but is not limited thereto. Furthermore, the user input unit 1400 may obtain commands through the utterance of the user based on the voice recognition technology.

According to an embodiment of the present invention, the user input unit 1400 may include a display for displaying an operation situation of the massage device 100 or a current state of the user. In this case, the display may include at least one among a liquid crystal display (LCD), a thin film transistor-liquid crystal display (TFT-LCD), an organic light-emitting diode (OLED) display, a flexible display, and a three-dimensional (3D) display, but is not limited thereto.

The audio output module 1500 may provide a user with an audio output of any form. For example, the audio output module 1500 may output a sound source and/or a binaural beat optimized for a massage pattern provided to the user by the massage device 100, thereby providing a brain stimulation to the user. The audio output module 1500 may output a sound signal received through a network (not illustrated) or stored in an internal/external storage medium (not illustrated). For example, the audio output module 1500 may output a sound source according to the control of the user terminal through a network connection (e.g., Bluetooth connection, etc.) with the user terminal. Additionally, the audio output module 1500 may output a sound signal generated in relation to the operation of the massage device 100.

The massage device 100 according to an embodiment of the present invention may include a network connection unit 1600. The network connection unit 1600 may communicate with a module inside the massage device 100, an external massage device, and/or a user terminal through any type of network. The network connection unit 1600 may include a wired/wireless access module for network access. The wireless access technology may include, for example, wireless LAN (WLAN) (Wi-Fi), wireless broadband (Wibro), world interoperability for microwave access (Wimax), high speed efficient downlink alliance (HSDPA), and the like. The wired access technology may include, for example, digital subscriber line (XDSL), fibers shop to the home (FTTH), power line communication (PLC), and the like. In addition, the network connection unit may include a short-range communication module to transmit and receive data to and from any device/terminal located at a short distance. For example, the short-range communication technology may include Bluetooth, radio frequency identification (RFID), infrared data security association (IrDA), ultra-wideband (UWB), ZigBee, and the like, but is not limited thereto.

As described above, the massage device 100 according to an embodiment of the present invention may include a massage module 1700. That is, the massage module 1700 may provide dynamic stimulation to the user, and the massage module 1700 may move along the main frame 1100.

The massage device 100 according to an embodiment of the present invention may include a main frame 1100. As described above with reference to FIGS. 1 to 3, the main frame 1100 may provide a path through which the massage module 1700 can move.

The control unit 1200 may control the operation of the massage module 1700 to apply mechanical stimulation to the user, thereby providing a massage.

The control unit 1200 may move the massage module 1700 in the X-axis, Y-axis, and Z-axis directions. The control unit 1200 may move massage balls forward on the X-axis, the Y-axis, and the Z-axis or retract the massage balls backward. Alternatively, the control unit 1200 may rotate the massage balls around the X-axis, the Y-axis, and the Z-axis.

The massage device 100 according to an embodiment of the present invention may include a sensor unit 1800. Here, the sensor unit 1800 may include at least one sensor. For example, the sensor unit 1800 may include a pressure sensor, an infrared sensor, an LED sensor, a photo sensor, a hall sensor, a capacitive sensor, and the like, but is not limited thereto.

The sensor unit 1800 may be used to acquire various pieces of information. For example, the sensor unit 1800 may be used to recognize a user. That is, information on whether the user is sitting in the massage device, the body shape of the user, whether there is any abnormality in the user's body, or the like may be obtained. As another example, the sensor unit 1800 may be used to acquire biometric information. That is, fingerprint information, face information, voice information, iris information, weight information, electrocardiogram information, body composition information, and the like may be obtained, but the present invention is not limited thereto, and may include various pieces of biometric information.

According to another embodiment of the present invention, the massage device 100 may sense a contact area and/or a contact position with the user through a sensor unit 1800. Furthermore, the massage device 100 may acquire information on the user's shoulder position through the sensor unit 1800. Moreover, the massage device 100 may provide a customized massage based on the acquired information. For instance, in a case in which the massage device 100 provides a shoulder massage, the massage device 100 may recognize the user's shoulder position based on the acquired information through the sensor unit 1800, and provide a shoulder massage to the user according to the recognition result.

The leg massage part 2000 may be a component to massage the user's leg. The leg massage part 2000 may include a leg accommodation space 2100 in which the user's leg is accommodated.

The leg massage part 2000 may include at least one among an air cell (not illustrated), a calf massage module (not illustrated), and a foot massage part (not illustrated).

The air cell (not illustrated) may be a component for fixing at least a portion of the body of the user. The air cell included in the leg massage part 2000 may be a component to expand by receiving air from an air supply unit to fix at least a portion of the body of the user.

The calf massage module (not illustrated) may be a component to massage a calf portion of the accommodated leg of the user. In this instance, the calf massage module may include a ball massage part or a roller massage part as described above, but is not limited thereto.

The foot massage part (not illustrated) may be a component to massage the user's foot. The foot massage part may include a foot massage module for massaging the user's foot. Here, the foot massage module may include a ball massage part or a roller massage part as described above, but is not limited thereto.

Hereinafter, a massage device 100 including a rotatable arm massage part according to an embodiment of the present invention will be described in detail with reference to the drawings.

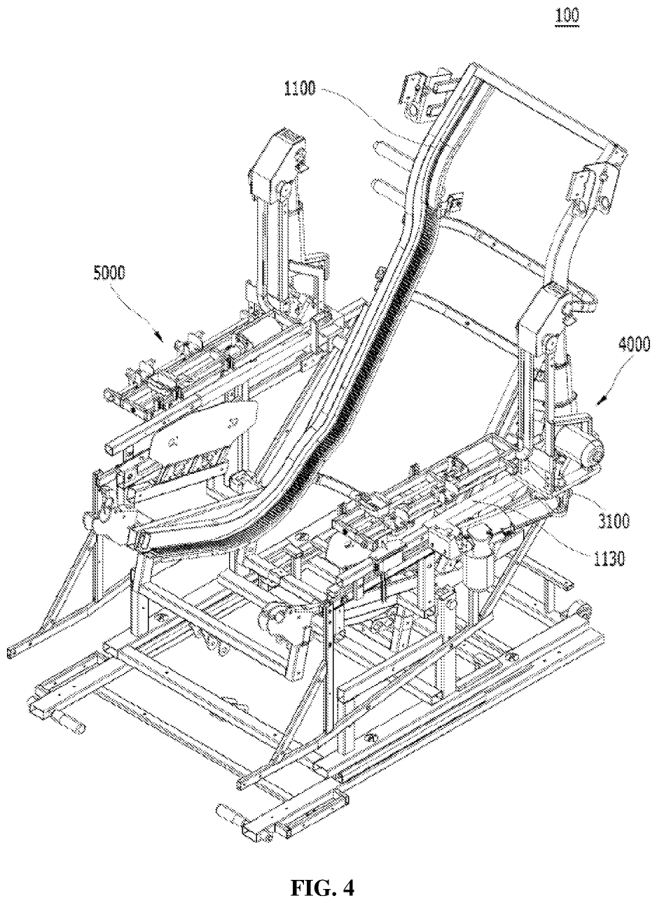

FIG. 4 is a view illustrating a rotation module 4000 and an arm length adjusting module 5000 provided in the main frame 1100 of FIG. 2.

Referring to FIGS. 1 and 4, the massage device 100 according to an embodiment of the present invention includes a body massage part 1000 having a main frame 1100 forming a framework of the massage device 100 and massaging the body of a user, and arm massage parts 3000 arranged at both sides of the body massage part 1000 and respectively accommodating the arms of the user to massage the arms of the user. The main frame 1100 includes an arm fixing frame 1130 to which the arm massage part 3000 is connected, and the arm massage part 3000 may include an arm moving frame 3100 rotatable in at least one direction based on the arm fixing frame 1130.

As described above, the body massage part 1000 may be a means for providing a massage to at least a portion of the body of the user. For example, the body massage part 1000 may include a space for accommodating at least a portion of the body of the user.

In an embodiment, the accommodation space of the body massage part 1000 may be a space in which a user sits. That is, the user may sit in the space formed in the body massage part 1000, and receive a massage in a sitting state.

The main frame 1100 may be a means disposed inside the body massage part 1000 to form a frame of the body massage part 1000.

As an alternative embodiment, the body massage part 1000 may include a cover for covering the massage module 1700 disposed therein so that the massage module 1700 is not exposed to the outside.

As an alternative embodiment, the massage device 100 according to an embodiment of the present invention may further include a leg massage part 2000. The leg massage part 2000 may be a means for providing a leg massage to the user. For example, the leg massage part 2000 may include a calf massage part for massaging the user's calf and/or a foot massage part for massaging the user's foot.

The leg massage part 2000 may include a space for accommodating at least a portion of the leg of the user. The user may insert a leg into the space formed in the leg massage part 2000 to receive a massage in a state in which the leg is inserted into the leg massage part 2000.

The arm massage part 3000 may be a means for massaging or stretching the user's arm. For example, the arm massage part 3000 may include a massage module 1700 for providing a massage to the user's arm.

Meanwhile, as will be described below, since the arm massage part 3000 may be rotated in at least one direction to provide stretching, massage, or other medical treatment to the user, it should be understood that providing a massage to the user's arm includes not only simply providing pressing, tapping, and rubbing but also providing stretching and other medical treatment performed by rotating or extending the user's arm in a specific direction.

The arm massage parts 3000 may be disposed at both sides of the body massage part 1000. For example, the arm massage parts 3000 may be respectively disposed at positions corresponding to both arms of the user. Each arm massage part 3000 may include a space for accommodating the user's arm.

In an embodiment, the arm massage part 3000 may include an arm massage part housing 3300. The arm massage part housing 3300 may be a structure into which the user's arm is inserted, for example, a structure into which the user's forearm is inserted.

The arm massage part housing 3300 can be connected to the arm moving frame 3100 to form the arm massage part 3000. That is, the user can insert the arm into the arm massage part housing 3300 to receive a massage, and as will be described later, as the arm moving frame 3100 rotates, the arm massage part housing 3300 can simultaneously rotate, thereby allowing the overall arm massage part 3000 to rotate.

In an embodiment, the main frame 1100 can include an arm fixing frame 1130 to which the arm massage part 3000 is connected. For instance, the arm fixing frames 1130 can be positioned on both sides of the body massage part 1000, respectively, and each arm massage part 3000 may be arranged on each arm fixing frame 1130. Therefore, in a state in which the user sits on the body massage part 1000, the user can insert the arms into the arm massage part 3000 to receive a massage.

In an embodiment, the arm massage part 3000 may be rotatable in at least one direction. Preferably, the arm massage part 3000 may rotate in the vertical direction and the horizontal direction based on FIG. 4. The massage device 100 according to an embodiment of the present invention may further include a rotation module 4000 for rotating the arm massage part 3000 in at least one direction. The rotation module 4000 will be described in detail later.

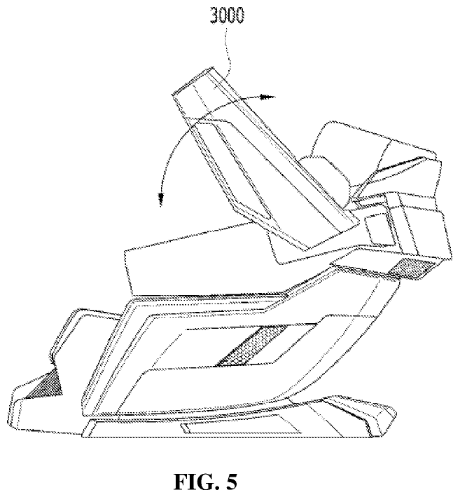

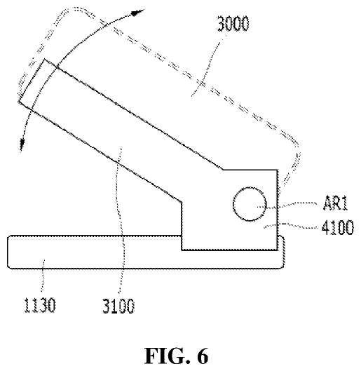

FIG. 5 is a view illustrating that an arm massage part rotates in one direction, and FIG. 6 is a view for depicting a rotation principle of the arm massage part of FIG. 5.

Referring to FIGS. 5 and 6, the arm massage part 3000 is rotatable in the vertical direction. For example, the arm massage part 3000 may rotate in the vertical direction while accommodating the user's arm in a state in which the user sits on the massage device 100.

To this end, the main frame 1100 can have arm fixing frames 1130 positioned on both sides, and the arm massage part 3000 can be coupled to the arm fixing frame 1130. At this time, the arm massage part 3000 can include an arm moving frame 3100 that is rotatable in a vertical direction based on the arm fixing frame 1130.

Therefore, when the arm massage part 3000 is connected to the arm fixing frame 1130, the arm moving frame 3100 can rotate in the vertical direction based on the arm fixing frame 1130, and the arm massage part 3000 can rotate in the vertical direction.

In a selective embodiment, the arm fixing frame 1130 is configured to extend toward the front side of the user to have a length in the state in which the user sits on the massage device 100. Thus, even when the user's arm is placed in the arm massage part 3000, the present invention can sufficiently bear the weight of the user's arm. Additionally, the force generated by the rotation module 4000 can be efficiently transferred to the arm massage part 3000, allowing stable rotation of the arm massage part 3000.

As an alternative embodiment, the arm massage parts 3000 on both sides may be independently rotatable. For example, in a case in which the arm massage part 3000 on one side rotates in the vertical direction, the arm massage part 3000 on the other side may not rotate or may rotate in the horizontal direction. Alternatively, both of the arm massage parts 3000 rotating in the vertical direction may be different from each other in angle, strength, and speed. Accordingly, the rotation module 4000 may be disposed at both sides of the body massage part 1000 to correspond to the pair of arm massage parts 3000. In addition, the rotation module 4000 may be controlled independently of each other to independently rotate the arm massage parts 3000 on both sides.

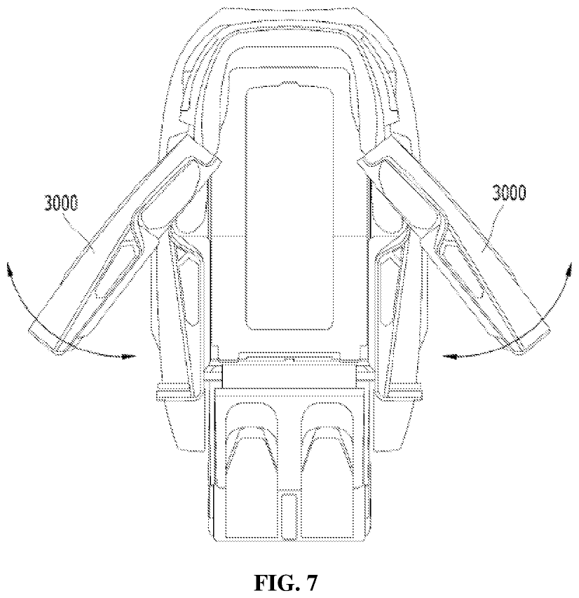

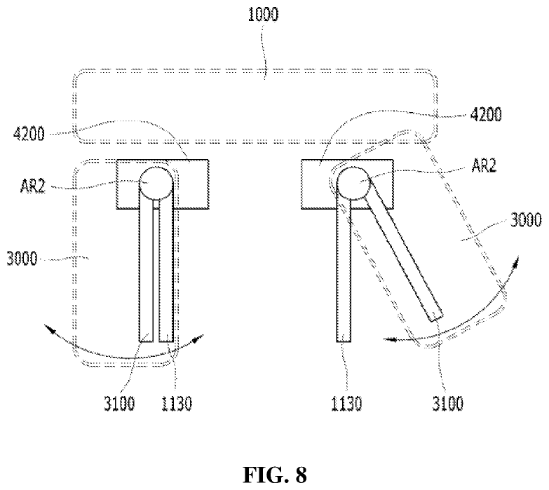

FIG. 7 is a view illustrating that the arm massage parts 3000 rotate in different directions, and FIG. 8 is a view for depicting the rotation principle of the arm massage parts 3000 of FIG. 7.

Referring to FIGS. 7 and 8, the arm massage part 3000 may be rotatable in the horizontal direction. For example, the arm massage part 3000 may rotate in the horizontal direction while the user's arm is accommodated in the arm massage part in a state in which the user sits on the massage device 100.

To this end, as described above, the main frame 1100 may have arm fixing frames 1130 arranged on both sides, and the arm fixing frames 1130 may be coupled with the arm massage parts 3000 respectively. At this time, the arm massage part 3000 may include an arm moving frame 3100 that can rotate in a horizontal direction based on the arm fixing frame 1130.

Therefore, when the arm massage part 3000 is connected to the arm fixing frame 1130, the arm moving frame 3100 can rotate in the horizontal direction based on the arm fixing frame 1130, and the arm massage part 3000 can rotate in the horizontal direction.

In a selective embodiment, the arm fixing frame 1130 is configured to extend toward the front side of the user to have a length in the state in which the user sits on the massage device 100. Thus, even when the user's arm is placed in the arm massage part 3000, the present invention can sufficiently bear the weight of the user's arm. Additionally, the force generated by the rotation module 4000 can be efficiently transferred to the arm massage part 3000, allowing stable rotation of the arm massage part 3000.

Furthermore, as described above, in a selective embodiment, the arm massage parts 3000 on both sides may be independently rotatable. For example, in a case in which the arm massage part 3000 on one side rotates in the horizontal direction, the arm massage part 3000 on the other side may not rotate or may rotate in the vertical direction. Alternatively, both of the arm massage parts 3000 rotating in the horizontal direction may be different from each other in angle, strength, and speed. Accordingly, the rotation module 4000 may be disposed at both sides of the body massage part 1000 to correspond to the pair of arm massage parts 3000. In addition, the rotation module 4000 may be controlled independently of each other to independently rotate the arm massage parts 3000 on both sides.

As described above, the arm massage part 3000 may be rotated in the vertical direction or in the horizontal direction to provide a stretching function or a rehabilitation exercise function to the user's arm. For example, the arm massage part 3000 may provide a stretching function by rotating the user's arm while rotating in the vertical or horizontal direction in a state in which the user's arm is accommodated therein. Alternatively, in a case in which the user is wounded in the arm, the arm massage part 3000 may provide a rehabilitation function to allow the user to perform a rehabilitation exercise by rotating in a state in which the user's arm is accommodated in the arm massage part. Alternatively, the arm massage part may provide an exercise function by rotating by a magnetic force in a state in which the rotation module 4000 is not driven. That is, since the arm massage part 3000 is configured to rotate in the vertical direction and in the horizontal direction, the user may perform muscular strength exercise by manually rotating the arm massage part 3000.

As an alternative embodiment, the arm massage parts 3000 may further include a load sensor for measuring a load. For example, the load sensor may measure a force applied from the rotation module 4000 to rotate the arm massage part 3000. In a case in which the force is greater than or equal to a predetermined value, the load sensor may recognize that the user's arm has been rotated as much as a limit value that the user's arm is no longer rotated, and transmit a control signal to the control unit 1200 to stop the rotation of the arm massage part 3000. In addition, the load sensor may measure a load applied to the arm massage part 3000 by the user's arm. In a case in which the force is greater than or equal to a predetermined value, the load sensor may recognize that the user intends to manually control the arm massage part 3000, and transmit a control signal to the control unit 1200 to change the rotation operation of the arm massage part 3000 into the manual mode.

As another alternative embodiment, the arm massage part 3000 may further include a jamming prevention sensor for detecting that at least a portion of the body of the user is caught. For example, the jamming prevention sensor may transmit a control signal for stopping the rotation of the arm massage part 3000 to the control unit 1200 in a case in which the jamming prevention sensor senses that the user's body is caught at a predetermined position while the arm massage part 3000 rotates. Accordingly, stability of the user's body may be further improved.

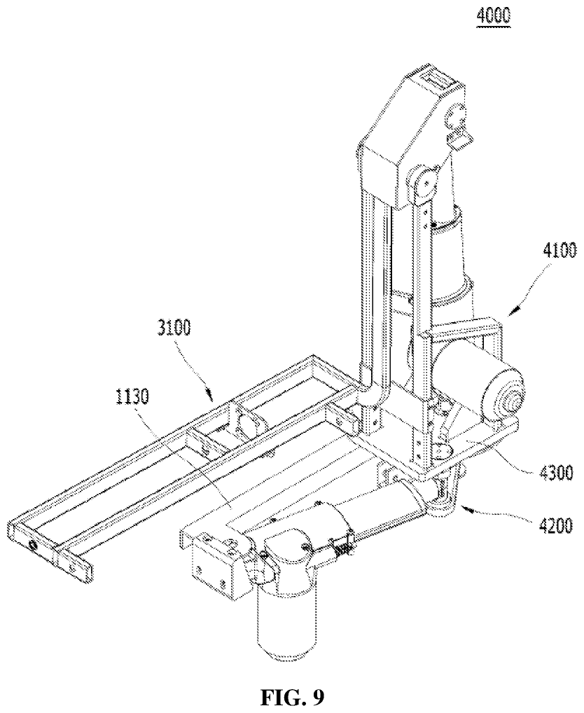

FIG. 9 is a view illustrating the rotation module 4000 of FIG. 4.

Referring to FIG. 9, the massage device 100 according to an embodiment of the present invention may further include a rotation module 4000 for rotating the arm massage part 3000 in at least one direction.

In an embodiment, the rotation module 4000 may include a first rotation module 4100 rotating the arm massage part 3000 in a vertical direction based on FIG. 9, and a second rotation module 4200 rotating the arm massage part 3000 in the horizontal direction. In this instance, the first rotation module 4100 and the second rotation module 4200 may be driven based on a motor.

Herein, the arm massage part 3000 may include the arm moving frame 3100 as previously described. The first rotation module 4100 and the second rotation module 4200 are capable of rotating the arm massage part 3000 by rotating the arm moving frame 3100. Further details will be described later.

In one embodiment, the rotation module 4000 is positioned between the first rotation module 4100 and the second rotation module 4200, and may include a support plate 4300 having one side connected to the first rotation module 4100 and the other side connected to the second rotation module 4200.

The support plate 4300 may be formed as a plate with a width. Referring to FIG. 9, the first rotation module 4100 is connected to the upper portion of the support plate 4300, and the second rotation module 4200 is connected to the lower portion of the support plate 4300.

The first rotation module 4100 can be fixedly connected to the upper portion of the support plate 4300. That is, the support plate 4300 is coupled to the first rotation module 4100 to support the first rotation module 4100 so that the first rotation module 4100 is fixed at a predetermined position.

Specifically, the first rotation module 4100 is positioned at the upper portion of the support plate 4300, and can be located behind the user's elbow in a state in which the user sits on the massage device 100. Thus, when the arm massage part 3000 rotates either horizontally or vertically, the arm massage part 3000 is not obstructed by the first rotation module 4100, and can be arranged to have spatial efficiency.

The second rotation module 4200 may be connected to the lower portion of the support plate 4300, and the support plate 4300 may be rotated by the second rotation module 4200. For instance, the second rotation module 4200 can rotate the support plate 4300, and consequently, the first rotation module 4100 connected to the upper portion of the support plate 4300 rotates to enable the arm massage part 3000 to rotate horizontally.

Specifically, the second rotation module 4200 is located on the bottom of the support plate 4300 and can be positioned on both sides of the massage device 100, and can be placed lower than the user's forearm. Thus, when the arm massage part 3000 rotates either horizontally or vertically, the arm massage part is not obstructed by the second rotation module 4200, and can be arranged with spatial efficiency.

Further details regarding the operation of the second rotation module 4200 will be described later.

As described above, the arm massage part 3000 can rotate in both vertical and horizontal directions, and the arm massage parts 3000 on both sides can rotate independently of each other. Therefore, by simultaneously rotating in vertical and horizontal directions, the present invention can provide the user with the stretching function similar to stretching the user's limbs or the exercise function.

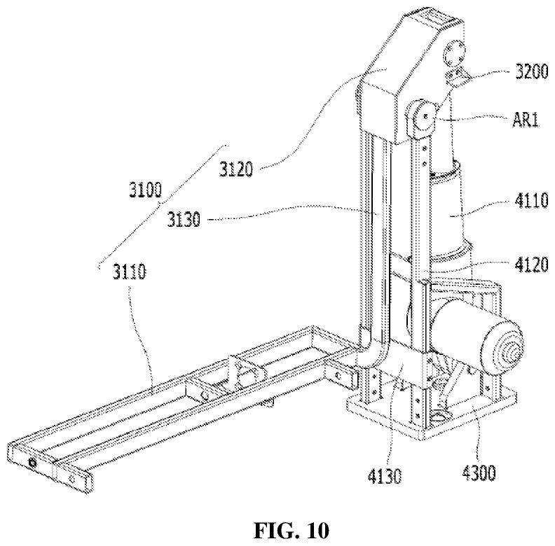

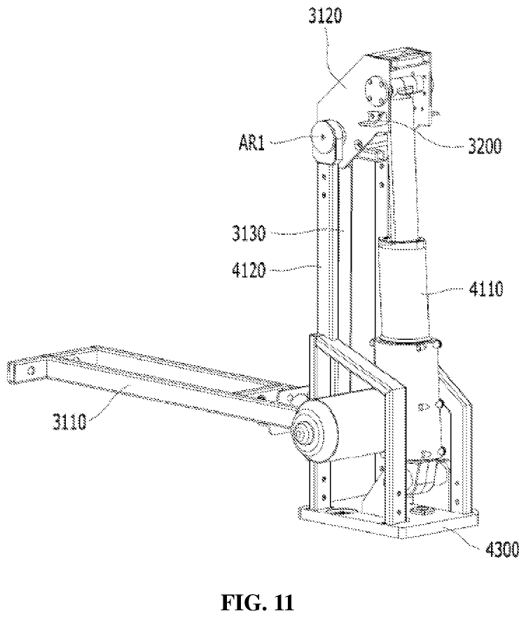

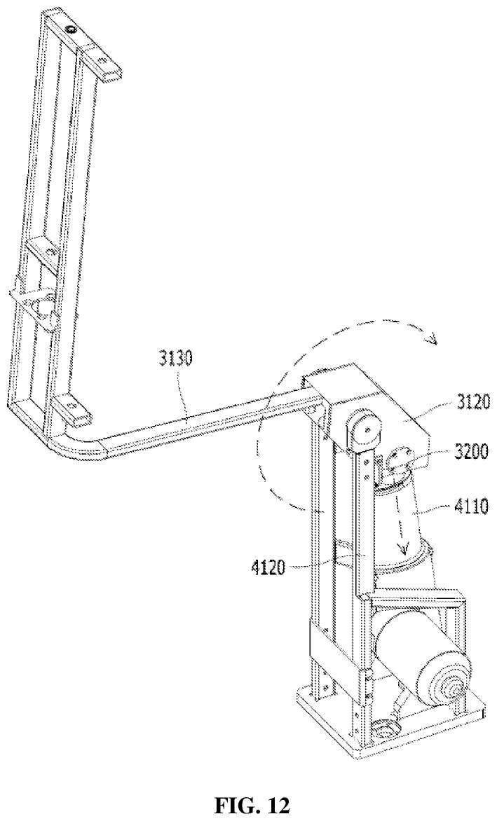

FIG. 10 is a view illustrating a first rotation module of FIG. 9, FIG. 11 is a view illustrating the first rotation module of FIG. 9 viewed from another angle, and FIG. 12 is a view illustrating an operational principle of the first rotation module of FIG. 9.

Referring to FIGS. 10 through 12, the first rotation module 4100 may include a first rotation actuator 4110 generating power to rotate the arm massage part 3000 in the vertical direction and a support frame 4120 extending toward one side from the support plate 4300 and connected to the arm moving frame 3100.

The first rotation actuator 4110 can be a linear actuator that extends in a specified direction. For instance, the first rotation actuator 4110 can be powered by electricity and can be driven linearly by the supplied electricity.

The first rotation actuator 4110 can be connected to the arm moving frame 3100, and by extending in one direction, can rotate the arm moving frame 3100 vertically.

In one embodiment, the arm moving frame 3100 may include an arm connection part 3110, a rotating part 3120 that rotates by connecting to the first rotation actuator 4110, and an extension part 3130 connecting the arm connection part 3110 and the rotating part 3120.

The arm connection part 3110 may be a portion that connects to the arm massage housing 3300.

The arm connection part 3110 may be formed extending in the length direction of the arm massage part 3000, and can couple with the arm massage housing 3300 of the arm massage part 3000. Therefore, when the arm moving frame 3100 rotates by the first rotation actuator 4110, the arm massage part 3000 can rotate entirely. Moreover, since the arm connection part 3110 is formed to extend in the length direction of the arm massage part 3000, the arm connection part 3110 can be fastened to the arm massage housing 3300 at multiple points, thus ensuring a more robust connection between the arm connection part 3110 and the arm massage housing 3300.

The rotating part 3120 may be configured to be connected to the first rotation actuator 4110 and the support frame 4120 and to be rotated by the operation of the first rotation actuator 4110.

Specifically, the rotating part 3120 can be rotatably connected to the first rotation actuator 4110 at one position, and can be connected to the support frame 4120 at the other position. At this time, the position where the rotating part 3120 is connected to the first rotation actuator 4110 may be a portion that allows rotation in accordance with the extension of the first rotation actuator 4110. Additionally, the portion where the rotating part 3120 is connected to the support frame 4120 can be fixed, and hence, the portion can become a rotation axis AR1 of the rotating part 3120.

When the rotating part 3120 rotates, the extension part 3130 and the arm connection part 3110 connected to the rotating part 3120 can also rotate together. That is, as the rotating part 3120 rotates by the first rotation actuator 4110, the arm moving frame 3100 can rotate in the vertical direction as a whole, thereby allowing the arm massage part 3000 to rotate vertically.

The extension part 3130 may be a portion that connects the arm connection part 3110 and the rotating part 3120. That is, when the rotating part 3120 rotates by the first rotation actuator 4110, the extension part 3130 can transmit the rotational force to the arm connection part 3110.

At this time, referring to FIG. 10, when the arm massage part 3000 is not rotated, the extension part 3130 can be formed to extend downwards from the rotating part 3120 towards the arm connection part 3110. Therefore, even if the first rotation actuator 4110 extends vertically, the rotational force by the extension can be easily transferred to the arm connection part 3110 located relatively below.

Referring to FIG. 12, the operation principle of the first rotation module 4100 will be described. The arm moving frame 3100 can rotate in the vertical direction by the extension of the first rotation actuator 4110.

Specifically, when the first rotation actuator 4110 contracts, the rotating part 3120 can rotate in a clockwise direction based on FIG. 12. At this time, the portion where the support frame 4120 and the rotating part 3120 are connected can become the rotation axis AR1 of the rotating part 3120.

Conversely, when the first rotation actuator 4110 extends, the rotating part 3120 can rotate in a counterclockwise direction based on FIG. 12. Similarly, the portion where the support frame 4120 and the rotating part 3120 are connected can become the rotation axis AR1, thereby allowing the extension part 3130 and the arm connection part 3110 to rotate counterclockwise, and enabling the arm massage part 3000 to rotate downwards.

In a selective embodiment, the arm moving frame 3100 may further include a first stopper 3200. For instance, the first stopper 3200 may be provided on the rotating part 3120 of the arm moving frame 3100.

The first stopper 3200 may serve as a means to set the upward rotation limit of the arm moving frame 3100.

Specifically, based on FIG. 10, the first stopper 3200 may be located on at least one side (left or right) of the rotating part 3120. The first stopper 3200 may be positioned on the left or right side of the rotating part 3120, may extend outward, and may have some width.

Therefore, when the rotating part 3120 rotates in a direction to lift the user's arm by to the first rotation actuator 4110, the first stopper 3200 can move in the direction of the support frame 4120 while rotating together. If the rotating part 3120 rotates to the maximum extent, as illustrated in FIG. 12, the first stopper 3200 may come into contact with the support frame 4120 to prevent further rotation. At this time, the upward rotation limit of the rotating part 3120 can be determined based on the position where the first stopper 3200 is located.

In another selective embodiment, the first rotation module 4100 may further include a second stopper 4130. The second stopper 4130 may be positioned on the support frame 4120 of the first rotation module 4100. The second stopper 4130 may serve as a means to set the downward rotation limit of the arm moving frame 3100.

Specifically, the second stopper 4130 may be located on a rotation route of the extension part 3130, may be positioned to connect both shafts of the support frame 4120, and may be arranged at the location where the extension part 3130 rotates to the maximum extent in the direction the user's arm descends. Therefore, when the extension part 3130 rotates in the direction of the descending user's arm and is obstructed by the second stopper 4130, the extension part 3130 can no longer rotate. The point of contact between the extension part 3130 and the second stopper 4130 may be the maximum rotation position of the extension part 3130.

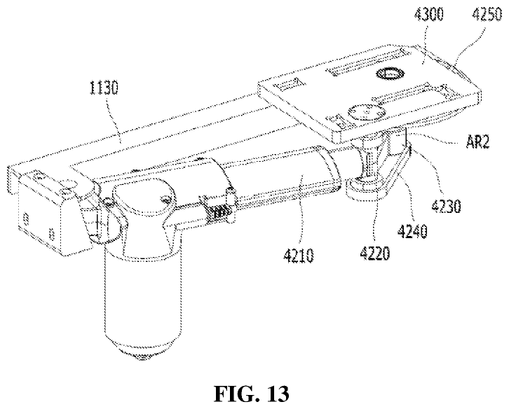

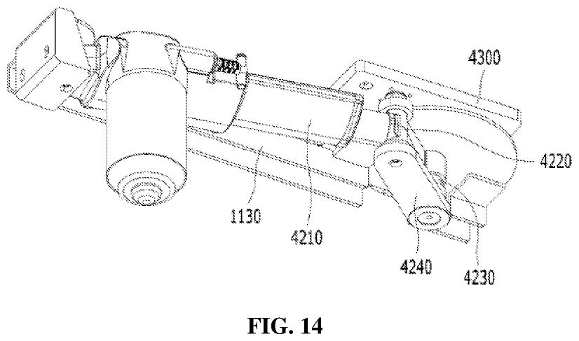

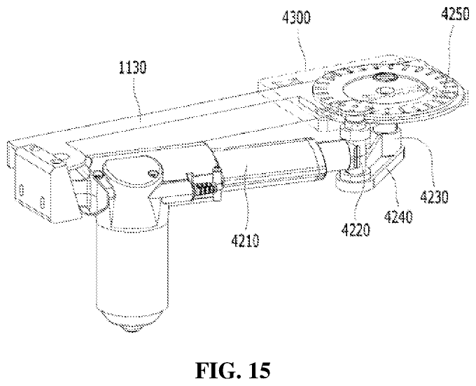

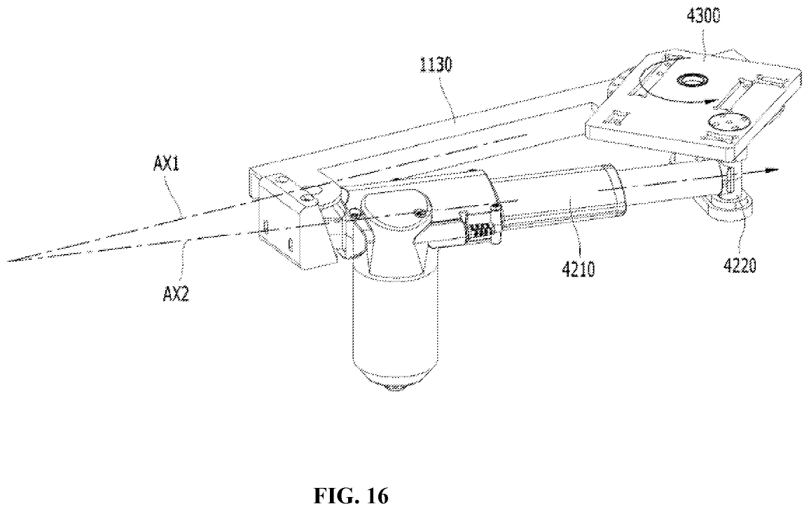

FIG. 13 is a view illustrating a second rotation module of FIG. 9, FIG. 14 is a view illustrating the second rotation module of FIG. 9 viewed from another angle, FIG. 15 is a view illustrating an example having a bearing provided on the second rotation module of FIG. 9, and FIG. 16 is a view illustrating an operational principle of the second rotation module.

Referring to FIGS. 13 to 16, the second rotation module 4200 may include a second rotation actuator 4210 that generates power to rotate the arm massage part 3000 in the horizontal direction.

The second rotation actuator 4210 can be a linear actuator that extends in a predetermined direction. For example, the second rotation actuator 4210 can receive power and be driven linearly by the supplied power.

The second rotation actuator 4210 may extend in a direction different from that of the first rotation actuator 4110. That is, since the direction that the first rotation actuator 4110 is extended and the direction that the second rotation actuator 4210 is extended are different from each other, the first rotation actuator and the second rotation actuator can rotate the arm massage part 3000 in different directions.

The second rotation actuator 4210 may be connected to a support plate 4300 and can rotate the support plate 4300 by extending in one direction. Consequently, the first rotation module 4100 connected to the support plate 4300 can rotate together, and the arm massage part 3000 connected to the first rotation module 4100 can also rotate horizontally together. At this time, the support plate 4300 and the first rotation module 4100 can be connected in a manner that fixes them together. Therefore, by the rotation of the support plate 4300, the first rotation module 4100 can rotate, and the arm massage part 3000 connected to the first rotation module 4100 can also rotate together.

The support plate 4300 and the second rotation module 4200 can be connected at multiple locations.

Specifically, the second rotation actuator 4210 can be combined with the support plate 4300 through a first connection part 4220. Therefore, when the second rotation actuator 4210 extends linearly, the second rotation actuator 4210 and the first connection part 4220 rotate relative to each other.

At this time, the support plate 4300 requires a rotation axis to rotate by the linear operation of the second rotation actuator 4210.

To this end, the second rotation actuator 4210 can be combined with the support plate 4300 through a second connection part 4230. At this time, the second connection part 4230 can serve as the rotation axis (AR2) of the support plate 4300. In order to serve as the rotation axis (AR2), the position of the second connection part 4230 should not change, notwithstanding the operation of the second rotation actuator 4210. Therefore, the second connection part 4230 can be connected to the arm fixing frame 1130 and be fixed in place.

The second rotation module 4200 may further include a connection plate 4240 connecting the first connection part 4220 to the second connection part 4230. For example, the connection plate 4240 may be formed to have an extended length, and the first connection part 4220 and the second connection part 4230 may be positioned at both ends. Therefore, when the first connection part 4220 moves by the second rotation actuator 4210, the connection plate 4240 can rotate while the second connection part 4230 remains fixed in place, thereby enabling the support plate 4300 to rotate easily.

Referring to FIG. 16, the operational principle of the second rotation module 4200 will be described. When the second rotation actuator 4210 extends in one direction, the second connection part 4230 is fixed as the rotation axis (AR2) of the support plate 4300, and the first connection part 4220 pushes the support plate 4300 to the right based on FIG. 16, along with the extension of the second rotation actuator 4210. Consequently, the support plate 4300 rotates counterclockwise, and the arm massage part 3000 rotates by the rotation of the connected first rotation module 4100.

Conversely, when the second rotation actuator 4210 contracts in the opposite direction, the second connection part 4230 remains fixed as the rotation axis (AR2) of the support plate 4300, and the first connection part 4220 pulls the support plate 4300 to the left based on FIG. 16, with the contraction of the second rotation actuator 4210. Consequently, the support plate 4300 rotates clockwise, and the arm massage part 3000 rotates by the rotation of the connected first rotation module 4100.

In one embodiment, in order to rotate the support plate 4300 by the operation of the second rotation actuator 4210, a virtual extension line (AX1) extending in the length direction of the arm fixed frame and a virtual extension line (AX2) extending in the direction in which the second rotation actuator 4210 of the second rotation module 4200 extends can intersect with each other. This means the extension line (AX1) in the length direction of the arm fixed frame and the extension line (AX2) in the extension direction of the second rotation actuator 4210 are not parallel to each other. In this manner, with the two extension lines crossing each other, the support plate 4300 can easily rotate due to the extension of the second rotation actuator 4210.

In a selective embodiment, the rotation module 4000 may further include a bearing 4250 positioned between the second rotation module 4200 and the support plate 4300. The bearing 4250 may be formed as a disc shape with a roughly formed internal hole.

The bearing 4250, positioned between the second rotation module 4200 and the support plate 4300, may serve as a means to adjust the center of gravity of the support plate 4300 to which the first rotation module 4100 is coupled. For instance, since the first rotation module 4100 is positioned on the upper portion of the support plate 4300, a predetermined amount of load can be applied to the support plate 4300. Furthermore, for the support plate 4300 to rotate by the second rotation module 4200, a predetermined distance must be maintained between the support plate 4300 and the second rotation module 4200. Thus, when no separate component is placed in the gap between the separated support plate 4300 and the second rotation module 4200, the support plate 4300 may be tilted in one direction or the connected axis area may be bent due to the load on the support plate 4300.

In order to address such an issue, the bearing 4250 is positioned between the second rotation module 4200 and the support plate 4300 to prevent the support plate 4300 from being biased to one side.

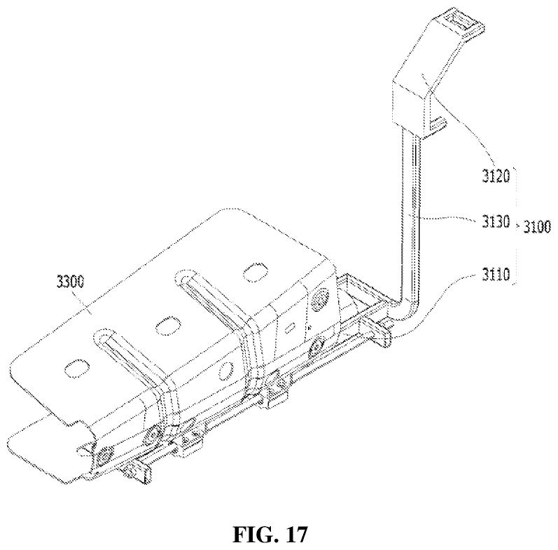

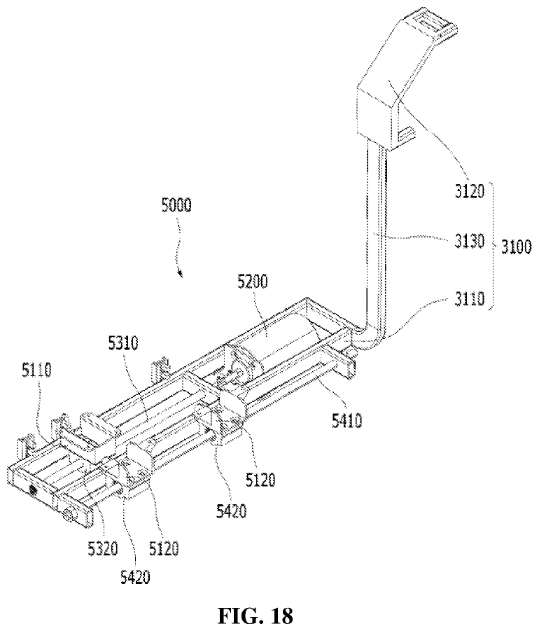

FIG. 17 is a view illustrating the arm length adjusting module of FIG. 4, and FIG. 18 is a view illustrating a state in which an arm massage part housing is removed from FIG. 17.

Referring to FIGS. 17 and 18, the massage device 100 according to an embodiment of the present invention may include an arm length adjusting module 5000 for adjusting the length of the arm massage part 3000.

The arm massage part 3000 can accommodate the user's arm, such as a user's forearm. For this, the arm massage part 3000 may include an arm massage part housing 3300 capable of accommodating the user's forearm. The arm massage part housing 3300 has a space where the user's forearm can be inserted, and the user can insert the forearm into the space to receive a massage.

Therefore, the arm length adjusting module 5000 can adjust the length of the arm massage part 3000 by moving the position of the arm massage part housing 3300 forwards and backwards. That is, in the state in which the user's forearm is inserted into the arm massage part housing 3300, the arm massage part housing 3300 can move forwards and backwards, and other components remain stationary, thereby adjusting the length of the arm massage part 3000.

The arm length adjusting module 5000 may include an arm length adjusting motor 5200 generating power to move the arm massage part housing 3300, a first moving member 5320 transferring the power generated from the arm length adjusting motor 5200 to the arm massage part housing 3300, and a first connection bracket 5110 connecting the first moving member 5320 to the arm massage part housing 3300.

In one embodiment, the arm length adjusting motor 5200 may be a means that receives power to generate rotation. At this time, the arm length adjusting motor 5200 can be connected to a lead screw 5310, and as the arm length adjusting motor 5200 rotates, the connected lead screw 5310 can also rotate.

The surface of the lead screw 5310 can be threaded. The lead screw 5310 can be positioned to penetrate a through-hole formed in the first moving member 5320. A groove that mates with the thread formed on the surface of the lead screw 5310 can be formed in the through-hole of the first moving member 5320. Therefore, as the lead screw 5310 rotates, the first moving member 5320 can move correspondingly.

The lead screw 5310 can be extended in a direction parallel to the movement direction of the arm massage part housing 3300. Accordingly, the lead screw 5310 can provide power to the first moving member 5320 while guiding its direction of movement.

In a selective embodiment, the arm length adjusting motor 5200 may be a type of motor including an air cylinder. For instance, the arm length adjusting motor 5200 can use an air cylinder to directly induce linear motion of the first moving member 5320. At this time, the lead screw 5310 may not have a thread on the surface of the lead screw 5310, and can function to guide the movement direction of the first moving member 5320.

In one embodiment, the arm length adjusting module 5000 can further include a guide bar 5410 and a second moving member 5420, positioned on one side of the arm connection part 3110 of the arm moving frame 3100, to guide the movement direction of the arm massage part housing 3300.

The guide bar 5410 may be a means to guide the movement direction of the arm massage part housing 3300.

The guide bar 5410 may be formed to be extended to have a length in a direction parallel to the lead screw 5310. Therefore, the movement direction of the arm massage part housing 3300 and the extension direction of the guide bar 5410 may be parallel.

The second moving member 5420 may be a means to move in the extended direction of the guide bar 5410. The second moving member 5420 may include a through-hole for the guide bar 5410 to penetrate. That is, the guide bar 5410 can be positioned to penetrate the second moving member 5420, and the second moving member 5420 can move in the extension direction of the guide bar 5410.

The arm length adjusting module 5000 may further include at least one second connection bracket 5120 that connects the second moving member 5420 and the arm massage part housing 3300. The second connection bracket 5120 may be a means to connect the second moving member 5420 and the arm massage part housing 3300.

Therefore, when the first moving member 5320 and the arm massage part housing 3300 connected to the first moving member 5320 move by the arm length adjusting motor 5200, the second moving member 5420 connected to the arm massage part housing 3300 can move simultaneously with the arm massage part housing 3300. At this time, the second moving member 5420 can guide the movement direction of the arm massage part housing 3300 by moving along the guide bar 5410.

The second connection bracket 5120 can be provided to correspond to the number of second moving members 5420.

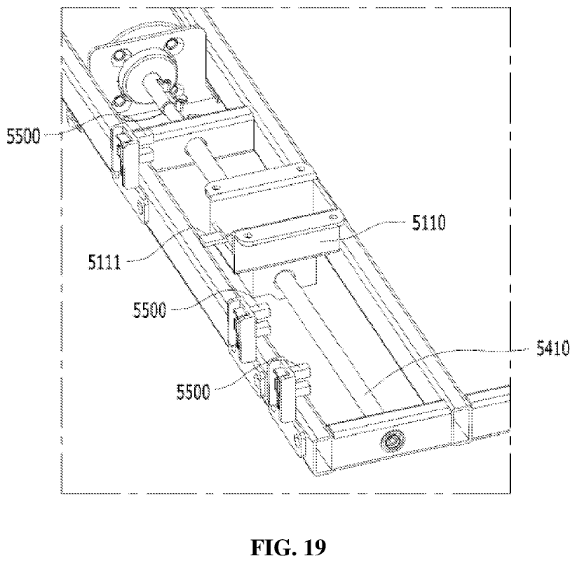

FIG. 19 is a view illustrating an example having an arm position sensor provided on the arm length adjusting module of FIG. 17.

Referring to FIG. 19, the arm length adjusting module 5000 may include an arm position recognition sensor 5500 recognizing the position of the arm massage part 3000.

At least one arm position recognition sensor 5500 may be positioned on one side of the arm connection part 3110 of the arm moving frame 3100. For example, multiple arm position recognition sensors 5500 may be arranged in the length direction of the arm connection part 3110.

In one embodiment, the arm position recognition sensor 5500 may be a photo sensor. For instance, the arm position recognition sensor 5500 may include a groove, and the first connection bracket 5110 may further include a protrusion 5111 that passes through a groove of the arm position recognition sensor 5500.

Specifically, when the first moving member 5320 moves by the arm length adjusting motor 5200, the first connection bracket 5110 can move along with the first moving member 5320. Accordingly, the protrusion formed on the first moving member 5320 can move in the movement direction of the first moving member 5320. At this time, the protrusion can pass through the arm position recognition sensor 5500, and the arm position recognition sensor 5500 can recognize whether the protrusion has passed through.

The arm position recognition sensor 5500 can transmit a recognition signal to the control unit 1200 when recognizing the passage of the protrusion. Accordingly, based on the information recognized by the arm position recognition sensor 5500, the control unit 1200 can ascertain the position of the arm massage part housing 3300. For example, when the arm position recognition sensor 5500 recognizes the passage of the protrusion, the control unit 1200 can determine the position of the arm massage part housing 3300.

Accordingly, when the massage device 100 is not in operation, the arm massage part 3000 can be placed in a default position. Moreover, when the arm length adjusting module 5000 adjusts the length of the arm massage part 3000, the arm length adjusting module 5000 becomes possible to determine how much the arm massage part 3000 has been extended or contracted.

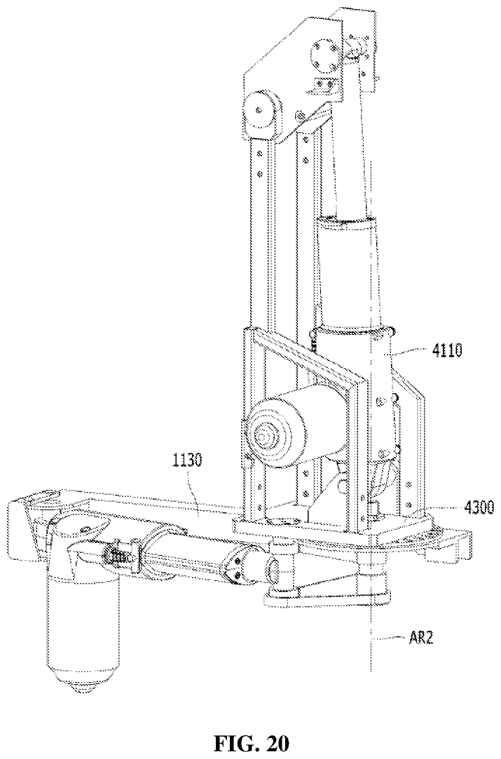

FIG. 20 is a view illustrating a position of a first rotation actuator.

Referring to FIG. 20, the first rotary actuator 4110 of the first rotation module 4100 can be located at the top of the support plate 4300 and can be arranged to be extended vertically.

At this time, the first rotary actuator 4110 may be arranged vertically based on the support plate 4300 to be extended vertically. Therefore, the load of the first rotary actuator 4110 may be concentrated on a relatively narrow area of the support plate 4300. In a case in which the load is biased only to a specific part of the support plate 4300, there is a problem that durability of the rotation module 4000 is reduced since the support plate 4300 is bent or tilted.

To overcome the problem, the first rotary actuator 4110 may be arranged on a virtual extension line extending along the rotation axis AR2 of the support plate 4300. For instance, the first rotary actuator 4110 may be placed near the second connection part 4230 connecting the support plate 4300 and the second rotation module 4200. Therefore, as described above, since the second connection part 4230 is connected to the arm fixing frame 1130, the second connection part 4230 can better withstand the load imposed by the first rotation module, and the first rotary actuator 4110 can be stably supported by the support plate 4300.

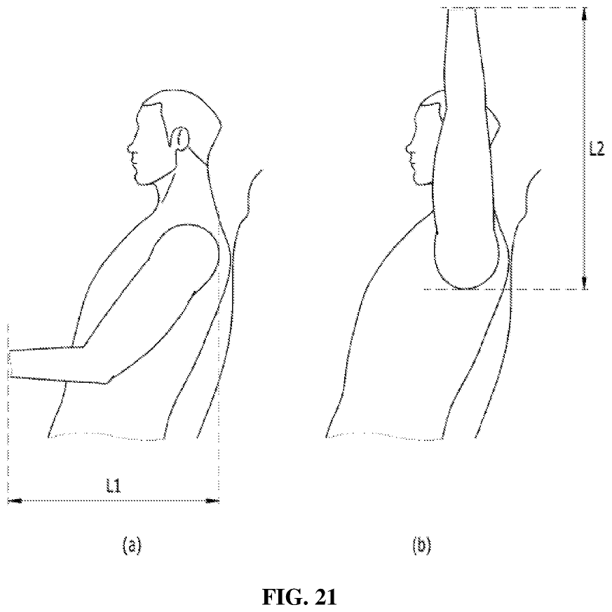

FIG. 21 is a view illustrating a change in length of the arm massage part according to angles of the arm.

Referring to FIG. 21, as an aspect of human anatomy, when a person is seated comfortably, it may be natural that the arm is bent based on the elbow. However, when the person lifts the hand or rotates the arm outwards, it is natural that the arm is stretched based on the elbow. Furthermore, it is even more natural to stretch the user's arm.

Accordingly, it is preferable that a distance (L1) from the shoulder to the wrist when the user does not rotate the arm is shorter than a distance (L2) from the shoulder to the wrist when the user raises or rotates the arm outward. That is, when the user's arm is raised or rotated outward, it is desirable to control the length of the arm massage part 3000 to increase the length of the arm massage part so as to compensate for the extended distance.

To this end, the massage device 100 according to an embodiment of the present invention may include a control unit 1200 controlling the operation of the massage device 100. The control unit 1200 can control the arm length adjusting module 5000 to adjust the length of the arm massage part 3000 based on the rotation amount of the arm massage part 3000.

That is, when the arm massage part 3000 rotates vertically or horizontally, the control unit 1200 can control the arm length adjusting module 5000 to naturally extend the user's arm. Specifically, the control unit 1200 can recognize the rotation extent of the arm massage part 3000, and can control the arm length adjusting module 5000 to increase the length of the arm massage part 3000.

Therefore, users can safely rotate the arms and receive the stretching or exercise function securely from the massage device 100.

Although the embodiments of the present invention have been described in more detail with reference to the accompanying drawings, the present invention is not necessarily limited to such embodiments, and may be variously modified without departing from the spirit of the present invention. Therefore, these embodiments as described above are only proposed for illustrative purposes and do not limit the present invention. The scope of protection of the present invention should be interpreted by the claims, and all technical ideas within the scope equivalent thereto should be construed as being included in the scope of the present invention.

1. A massage device comprising:
a body massage part including a main frame forming a framework of the massage device, and massaging a user's body; and
an arm massage part positioned on both sides of the body massage part, each accommodating an arm of the user to massage the user's arm,
wherein the main frame includes an arm fixing frame to which the arm massage part is connected, and
wherein the arm massage part includes an arm moving frame capable of rotating in at least one direction based on the arm fixing frame.

2. The massage device according to claim 1, further comprising:
a rotation module to rotate the arm massage part in at least one direction.

3. The massage device according to claim 2, wherein the rotation module comprises:
a first rotation module for rotating the arm massage part vertically, and
a second rotation module for rotating the arm massage part horizontally.

4. The massage device according to claim 3, wherein the first rotation module comprises a first rotation actuator extended in a predetermined direction, and
wherein the second rotation module comprises a second rotation actuator extended in a direction different from that of the first rotation actuator.

5. The massage device according to claim 4, wherein a virtual extension line extended in the length direction of the arm fixing frame and a virtual extension line extended in the extension direction of the second rotation module intersect with each other.

6. The massage device according to claim 3, wherein the rotation module comprises a support plate which is positioned between the first rotation module and the second rotation module, and has one side connected to the first rotation module and the other side connected to the second rotation module.

7. The massage device according to claim 6, wherein the support plate is rotated by the second rotation module.

8. The massage device according to claim 1, further comprising:
an arm length adjustment module to adjust the length of the arm massage part.

9. The massage device according to claim 8, wherein the arm length adjustment module comprises an arm position sensor to recognize the position of the arm massage part.

10. The massage device according to claim 8, further comprising:
a control unit controlling the operation of the massage device,
wherein the control unit controls the arm length adjustment module to adjust the length of the arm massage part based on the rotation amount of the arm massage part.
